(19) United States
(12) Patent Application Publication
(10) Pub. No.: US 2008/0113067 A1
(43) Pub. Date: May 15, 2008

(54) Protein-Containing Food Product and Coating for a Food Product and Method of Making Same

(76) Inventors: Monoj Sarma, Bourbonnais, IL (US); Felicidado Pugeda, Naperville, IL (US); Roger L. Daniels, Manhattan, IL (US)

Correspondence Address: Sandra B. Weiss;JONES DAY, 77 West Wacker Drive, Chicago, IL, 60601-1692, US

(21) Appl. No.: 11/939,111

(22) Filed: Nov. 13, 2007

Related U.S. Application Data
(63) Continuation-in-part of application No. 11/251,654, filed on Oct. 17, 2005.

(51) Int. Cl. A23D 7/005; A23L 1/48; A23P 1/00

(52) U.S. Cl. 426/89; 426/519; 426/602

(57) ABSTRACT

A method for forming a complex of a protein-containing material and a lipid-based material comprises the steps of admixing said protein-containing material into said lipid material, applying heat and a shear force to said admixture to form an emulsion of protein material in said lipid material, and cooling said admixture to form a lipid-protein complex. Optionally, a liquid grinding step also may be used. The complex comprises at least about 10-50 net weight % protein, preferably no more than about 1% of an emulsifier, and an amount of a lipid-containing material sufficient to form an emulsion with the protein containing material. It is believed that higher proportions of protein could be obtained in the emulsion with high capacity pumps and shear apparatus. The complex can be used as a coating composition for a food product, or as an ingredient in a coating composition for a food product, or as an ingredient in a food article. When used as or in a coating for a snack food item such as a protein-containing energy bar, the coating can add to the nutritive value of the bar, and maintain the moisture content of the bar.

This application is a continuation-in-part of U.S. patent application Ser. No. 11/251,654 filed Oct. 17, 2005, and claims the benefit thereof under 35 U.S. C §120.

### BACKGROUND OF THE INVENTION

This invention relates to edible solid compositions that can be used in food products or in coatings for food products, the compositions having enhanced protein content to provide greater nutritional benefit to the consumer. The invention further relates to lipid-protein complexes that can be used in the preparation of such edible solid compositions, and to methods for making such lipid-protein complexes. This invention further relates to food products comprising such lipid-protein complexes, and to food articles having such solid coatings, and to methods of their manufacture.

Many snack food items produced by the food industry are provided with a coating. Such coatings are used to maintain a desired moisture content in the coated food article, and to provide additional qualities to the food article that will enhance consumer appeal, such as flavor and mouth feel. Such coatings typically comprise fats, sugars, and other flavor enhancers.

In recent years, there has been increasing concern about high levels of consumption of both fat and sugar, and a corresponding concern about lower levels of protein consumption. The food industry has provided a variety of products intended to address those concerns. One such food product that has gained in popularity in recent years is a snack bar made with enhanced nutrients, and especially a higher protein content. In standard confectionery items, protein comes from four main sources—milk, egg whites, soy products, and grains. The protein content in these standard items is relatively low, typically about 5.7% of total calories in soft nougat and about 2.3% of total calories in caramel. For nutritionally enhanced functional confections, in which protein levels are about 20-30% of total calories, concentrated protein sources are required (Jeffery, Maruice, S. “Functional Confectionery Technology”; The Manufacturing Confectioner: August, 2004; pp. 51-52.) These bars are known to consumers variously as “energy bars,” “nutrition bars,” “health bars,” and “sports bars.” They are intended to provide sustained energy and enhanced nutritional value to the consumer. The concentrated protein in such bars is hygroscopic, and can absorb moisture from the other ingredients in the bar, making the bar hard and less appealing to the consumer. Increased protein can make it difficult to maintain a desired moisture level in the bar. Some energy bar products are provided with a coating to help maintain the moisture level of the bar. Such coatings typically include sugar, fat, cocoa powder, non fat dry milk, salt, and lecithin. In some products, the sugar may be replaced with one or more sugar alcohols, such as maltitol or lactitol and other artificial sweeteners such as sucralose, saccharin and aspartame. It would be desirable to provide a coating composition with a higher protein content for such products to provide an additional health benefit to consumers.

U.S. Pat. No. 3,514,297 discloses a continuous process of preparing powdered fat.

U.S. Pat. No. 4,212,892 discloses a high-protein snack food comprising a plastic protein gel that can be mixed with a dry starch or flour to obtain a homogeneous mass that can be extruded into desired shapes and cooked. The cooked product can be prepared in the form of chips and coated subsequent to cooking with flavoring and/or flavor-enhancing agents.

U.S. Pat. No. 4,762,725 discloses a non-aqueous, lipid-based, stable, flavored spreadable coating or filling having a smooth, non-grainy texture, spreadable at room temperature but capable of form retention when applied to a substrate at a temperature up to about 110° F., the coating comprising about 10-70% of a hydrogenated vegetable oil, about 30-90% of a particulate friable, non-hygroscopic bulking agent, flavoring, and about 0.1 to about 8% of a lipid stabilizer having a Capillary Melting Point in the range of about 125°-150° F., the vegetable oil and lipid stabilizer defining on cooling a lipid matrix for the bulking agent, the bulking agent being substantially impalpable in the lipid matrix. At column 11, lines 60 et seq., the patent states that the essence of its invention is the discovery that a spreadable filling can be made using an oil rather than shortening by stabilizing the oil with a high melting point lipid. The bulking agent is preferably selected from the group consisting of cocoa powder, dried cheese powder, bland dairy-derived protein, bland vegetable protein, bland corn syrup solids, and combinations thereof.

U.S. Pat. No. 4,767,637 discloses a crumb coating for foods in which a liquid batter is coagulated into a sheet, the sheet is deep fat fried, and the fried sheet is milled into crumbs.

U.S. Pat. No. 4,851,248 discloses a process of making a confectionery product having discrete articles applied to the outer surface and then coated with a suitable confectionery coating.

U.S. Pat. No. 5,258,187 discloses a food coating comprising rice starch.

U.S. Pat. No. 5,401,518 discloses a coating formed from an emulsion prepared by homogenizing from about 70% to 90% by weight of an aqueous solution of a protein isolate and from about 30% to about 5% by weight of a mixture of a saturated lipid having a melting point higher than 30° C., and an emulsifier. The homogenization may be carried out with various homogenization apparati known to those skilled in the art, which include apparati known as a “high shear” type of apparati, and for periods ranging from one minute to about 30 minutes. The emulsifier is in an amount of from about 5% to about 30% by weight based upon the weight of the lipid and contains at least one diacetyl tartaric acid ester of a monoglyceride.

U.S. Pat. No. 5,431,945 discloses a process for the preparation of a dry butter flake product having a high milk fat content.

U.S. Pat. No. 5,753,286 discloses a two-part coating for a food product. The first part of the coating is a predust which contains a starch that is suitable for film forming and a water-soluble edible setting agent. The second part of the coating is a water-containing batter which contains dextrin and a composition which is settable by the setting agent in the first part of the coating. The finished coating is an oil and moisture barrier, and is crunchy.

U.S. Pat. No. 6,932,966 B2 discloses an apparatus and method for preparing solid flakes of fats and emulsifiers, the method allowing the application of a coating to the slake to assist in voiding loss of flake separation and to maintain pourability of the flaked product.

### SUMMARY OF THE INVENTION

It is thus one object of the invention to provide a lipid-protein complex and a method of making a lipid-protein complex, the complex having enhanced protein content and which can be used as a solid food coating or in the preparation of a solid food coating composition, wherein the protein forms a stable emulsion with a lipid-containing material.

It is another object of the invention to provide a lipid-protein complex and a method of making a lipid-protein complex that can be used as a solid food coating or in the preparation of a solid food coating composition, the composition having enhanced protein content, and preferably no more than a small quantity of an emulsifier.

It is still another object of the invention to provide a food article having a coating prepared with a lipid-protein complex, the coating having an enhanced protein content, and a method of making such a coated food article.

It is still another object of the invention to provide a food product such as a snack product made with a lipid-protein complex, the food product having enhanced protein content, and a method of making such a food product.

Other objects, advantages, and novel features of the invention will be apparent from the following description and the Examples of the present invention set forth herein.

In accordance with one embodiment of the invention, a method for forming a complex of a protein-containing material and a lipid-based material comprises the steps of admixing a quantity of protein-containing material into a quantity of lipid-based material, applying a shear force to said admixture to form an emulsion of protein material in said lipid material, and cooling said admixture to form a lipid-protein complex. In one embodiment of the invention, the step of applying shear force to the admixture occurs substantially simultaneously with the step of admixing said quantity of protein-containing material into said quantity of lipid-based material. In another embodiment of the invention, the step of applying shear force to the admixture occurs substantially after the step of admixing said quantity of protein-containing material into said quantity of lipid-based material, and said method further including liquid grinding of the emulsion.

The protein-containing material used to make the lipid-protein complex can be in particulate form. The protein material can be in an instantized form, in which case it may include a small quantity of an emulsifier, or in a non-instantized form in which case it contains substantially no emulsifier. The particulate protein material in the lipid-protein complex can have an average particle size in the range of about 30-70 microns, which can be accomplished by mechanical grinding of the protein material before it is added to the emulsion, or by the aforementioned liquid grinding during the emulsification step. In either embodiment, the high shear can be applied by a mixer that operates in the range of about 4000-10000 and preferably about 4000-8000 rotations per minute. The lipid material is heated to a temperature in the range of about 125-150° F.

The lipid-protein complex so formed is suitable for use as an edible solid food coating, or as an ingredient for an edible solid food coating composition, or as an ingredient in a food product. The complex comprises at least about 10-50 net weight % protein, preferably no more than about 1% of an emulsifier, and an amount of a lipid-containing material sufficient to form an emulsion with the protein containing material.

### DESCRIPTION OF THE FIGURES

FIG. 1 is a flow sheet showing an embodiment of a process for making the lipid protein complex of the present invention using a two stage mixing process on a pilot plant scale.

FIG. 2 is a flow sheet showing an embodiment of a process for making the lipid protein complex of the present invention using a two stage mixing process scaled up to full scale plant production.

FIG. 3 is a graph showing the particle size distribution for a sample of lipid protein complex made with instantized whey that had been subjected to mechanical grinding, and with 0.45% finished lecithin in the finished lipid protein complex.

FIG. 4 is a graph showing the particle size distribution for a sample of lipid protein complex made with non-instantized whey having an initial particle size of about 50-80 microns and subjected to liquid grinding during the emulsification step, and with 0.10% lecithin in the finished lipid protein complex.

### DETAILED DESCRIPTION OF THE INVENTION

Throughout this patent application, all percentages are given in terms of weight percent. The term “lipid-protein complex” is sometimes abbreviated herein as “LPC.”

The present invention relates to lipid-protein complexes that are suitable for use in an edible solid food coating composition having a high protein content, and in food products, and to a method of making such lipid protein complexes. The method comprises the steps of admixing a quantity of protein-containing material into a quantity of lipid-based material, applying a shear force to said admixture to form an emulsion of protein material in said lipid material, and cooling said admixture to form a lipid-protein complex. The lipid-containing material is subjected to high shear and sufficient heat to initially increase the viscosity of the system. The protein-containing material can be added to the lipid-containing material while the lipid material is undergoing high shear, with the high shear being maintained for a period of time sufficient to create an emulsion of protein in the lipid. The admixture is then cooled. Due to the increase in viscosity of the composition upon heat and shearing action, the composition will form a solid protein/fat matrix when cooled, with properties and consistency similar to solid confectionery fats. Alternatively, the lipid-containing material and the protein-containing material can first be combined with high speed mixing to form an admixture, and the admixture then subjected to shear forces, as described more fully further below.

In the practice of one embodiment of the present invention, a lipid-containing material is added to a high-shear mixer, such as a Lightning brand mixer. Such mixers can operate at mixing speeds in the range of about 4000-10,000 rotations per minute or higher; a preferred range for the method of the present invention is about 4000-8000 rotations per minute. The lipid-containing material is heated to a temperature of about 125-150° F. and preferably about 130° F. Once the lipid-containing material is heated through, a stream of protein-containing material is added to the mixer, such as by an auger feeder. The protein-containing material can be in particulate form. The lipid-containing material and protein-containing material are mixed together for a period of time sufficient to create a thick emulsion of the protein particles in the matrix of lipid-containing material. Typically, mixing will continue for about 20-30 minutes. The lipid will surround each protein particle, causing the protein to soften somewhat.

In one embodiment of the invention, the admixture can be cooled first to a temperature of about 110° F., then cooled and crystallized through a crystallizer unit, such as a unit available under the commercial name VOTATOR®, to a temperature of about 45-52° F. or less to form a semi-solid. As the material crystallizes it releases the heat of crystallization, raising the temperature of the composition to about 65-70° F. The product then can be collected for final hardening as a confectionery fat. Alternatively, after cooling to a temperature of about 110° F. the mixture can be placed in a cooling chamber having a temperature of about 0-32° F., and preferably about 25° F. The choice of cooling technique will depend on the desired crystalline properties of the lipid-protein complex. If the product is to be substantially softened or melted by the food manufacturer before it is incorporated into the final food product, then the crystalline properties of the lipid-protein complex will be less critical.

The composition can be delivered either as a mass, or in solid cubes, or comminuted into flakes, or presented in a semi-solid or liquid form to be used as an ingredient in the manufacture of a finished solid coating. If delivered in a solid or semi-solid form, the material may need to be melted before use to the consistency of a liquid, such as by placing the container in a heating chamber at around 110-120° F. for about 24-36 hours. To form into flakes, the mixed protein-fat composition at around 110° F. can be fed into a flaking roll system to yield a protein/fat composition in the form of flakes for later use.

The lipid containing material can be derived from vegetable or animal sources. It can be non-hydrogenated, partially hydrogenated, fully hydrogenated, fractionated or interesterified, or any combination of such lipids, depending on the lipid material used and the desired properties of the final coating product. In a preferred embodiment, the lipid-containing material can include a lipid selected from the group consisting of palm kernel oil, fractionated palm kernel oil, palm kernel stearine, palm oil, canola oil, cottonseed oil, corn oil, soybean oil, sunflower oil, olive oil, peanut oil, coconut oil, cocoa butter, butter fat, dairy fat, and pure palm kernel stearine fractions, and blends of any of the foregoing. Both the domestic and off-shore oil products can be used in their non-hydrogenated, partially hydrogenated, or hydrogenated forms, or interesterified or fractionated, depending on the characteristics of the coating or food product that may be desired. In some embodiments it may be desirable to avoid hydrogenated lipid products to avoid the introduction of trans fats into the product for nutritional reasons. Commercially available oil products that have been found to be suitable for use in the method of the present invention include a refined, bleached, and deodorized (i.e., RBD) palm kernel oil sold by Fuji Vegetable Oil, Inc, 1 Barker Ave., White Plains, N.Y. 10601 USA under the name DF #14; a fractionated palm kernel stearine sold by AarhusKarlshamn 131 Marsh Street, Port Newark, N.J. 07114 USA under the name CE 21-20, and a palm kernel stearine sold by Premium Vegetable Oils (PVO) of Berhad, Malaysia under the name PKS 75. Other suitable lipid-containing materials will be recognized by those skilled in the art. Blends of any of the foregoing also can be selected to provide desired melting points and solid fat content profiles over a range of operating temperatures.

The protein-containing material comprises at least one protein selected from the group consisting of whey protein concentrate, whey protein isolate, whey protein hydrolysate, soy isolate, soy concentrate, milk casein, calcium caseinate, calcium sodium caseinate, milk protein isolates, pea flour, pea protein isolates, beta-lacto globulin, and alpha-lactalbumin. Whey protein hydrolysates and pea protein isolates are preferred. The protein-containing material used to make the lipid-protein complex can be in particulate form. The protein material can be in an instantized form, in which case it may include a small quantity of an emulsifier, or in a non-instantized form in which case it contains substantially no emulsifier. One whey protein hydrolysate product suitable for use in the present invention is Hilmar 8360 Instantized Whey Protein Hydrolysate (80% net protein), sold by Hilmar Ingredients of Hilmar, Calif. As is known in the art, such instantized products contain a small amount of lecithin. The Hilmar 8360 instantized whey protein product contains about 0.9% lecithin, as well as approximately 4.0% lactose, 5.8% fat, 3.4-4.1% moisture, and 5.2% ash.

The particulate protein material in the emulsion can have an average particle size in the range of about 30-70 microns, and preferably as low as about 10 microns. This can be accomplished by mechanical grinding of the protein-containing material before it is added to the emulsion, such as with a high energy jet grinder; such grinding can be performed, for example, by Fluid Energy Processing & Equipment Company (Fluid Energy Aljet), 4300 Bethlehem Pike, Telford, Pa. 18969. Alternatively, the desired average particle sizes can be achieved during the process of the present invention by the aforementioned liquid grinding. Generally, smaller particle size provides greater benefit in terms of product sheen and overall appearance as the percentage of protein in the composition increases. Smaller particle size also promotes emulsification of the protein in the lipid matrix. When such fine particles are admixed with the lipid-containing materials with high shear and heat, the particles are softened by the lipid-containing material and remain dispersed without settling.

A small amount of an emulsifier may be used to maintain the dispersion of the protein particles in the lipid-containing material. Suitable emulsifiers include lecithin and poly glycerol poly ricinoleate. Some emulsifier may already be present in instantized protein products. When such products are used, additional emulsifier can be added to the protein-lipid admixture in the amount of about 0.6% or less of the protein-lipid composition. When non-instantized protein products are used that contain substantially no emulsifier, additional emulsifier can be added to the protein-lipid admixture in the amount of about 1.0% or less of the protein-lipid composition.

The complex comprises at least about 10-50 net weight % protein, preferably no more than about 1% of an emulsifier, and an amount of a lipid-containing material sufficient to form an emulsion with the protein containing material. The complex can be about 10-50% net protein, preferably about 35-50% net protein, and most preferably about 50% of net protein. The amount of protein-containing product to be added to the mixture will depend on the percent of protein in the protein-containing material; for example, commercial protein hydrolysate products will have a different net protein content than commercial protein isolate products, as is known in the art. The amount of emulsifier will be less than 1% of the complex, preferably less than 0.5%, and most preferably less than 0.2%. The lipid-protein complex so made can be used as a coating for a food product, or as an ingredient in a coating for a food product, or in the manufacture of a protein-enriched food product such as a snack product.

### EXAMPLES 1-6

### Evaluation of Lipid-Containing Products

The following fats and blends were evaluated to determine their suitability for use in the present invention, by determining their melting points and solid fat contents over a range of temperatures as set forth in Table I below. The Mettler Drop Point (MDP) was measured by procedure AOCS Cc 18-80, and the solid fat content (SFC) at each of the temperatures indicated was measured by procedure AOCS Cd 10-57.

TABLE I
Evaluation of Lipid-Containing Products

| | | Mettler | | | | | |
|---|---|---|---|---|---|---|---|
| | | Drop Point | SFC (Solid Fat Content) | | | | |
| Example | Type | (MDP) (° C.) | 10° C. | 21.1° C. | 26.7° C. | 33.3° C. | 40.0° C. |
| 1 | PKO* | 31 | 70.6 | 41.0 | 9.9 | 0.1 | 0.8 |
| 2 | Fract. | 35 | 87.7 | 73.5 | 49.8 | 0.3 | 0.4 |
| | PKS** | | | | | | |
| 3 | PKS*** | 37 | 90.6 | 81.6 | 61.7 | 1.3 | 0.2 |
| 4 | 80% Ex 1/ | 32.3 | 73.1 | 50.1 | 18.7 | 0.6 | 0.1 |
| | 20% Ex 3 | | | | | | |
| 5 | 50% Ex 1/ | 34.1 | 79.1 | 62.5 | 34.4 | 0.4 | 0.2 |
| | 50% Ex 3 | | | | | | |
| 6 | 20% Ex 1/ | 36.0 | 85.2 | 73.5 | 50.9 | 0.1 | 0.4 |
| | 80% Ex 3 | | | | | | |

*Refined, bleached deodorized palm kernel oil, Fuji DF #14
**Fractionated palm kernel stearine, Arrhus CE 21-20
***Palm kernel stearine, Premium Vegetable Oils, PKS 75

Of the foregoing fats and blends, the most suitable products in terms of coating viscosity, setting time, adherence, and finished product stickiness were those made using the fractionated palm kernel oil product of Example 2 and the blend of 20% DF #14 (RBD palm kernel oil) and 80% PKS 75 (palm kernel stearine) of Example 6. The unblended palm kernel oil of Example 1 could be used to make a softer product.

The fat compositions of Examples 1, 2, 4, 5, and 6 were used to make coating compositions to evaluate their suitability for use as an ingredient in the preparation of solid coatings. For each of these fat compositions, a corresponding coating composition was prepared as follows. First a mixture of 926.1 grams sugar, 285.1 grams natural cocoa powder (10-12% fat), 54.5 grams non-fat dry milk and 1.4 grams of extra-fine salt were blended together in a 4-quart, hot water jacketed Hobart Mixer model # N-50 fitted with a standard mixing paddle. (Hobart Manufacturing Company, Troy, Ohio). These dry ingredients were then blended with 272.5 grams of the fat composition that had been heated in the same bowl to a temperature of about 105° F. at Hobart bowl speed #1, corresponding to about 60 rpm. This blended complex was then ground through a 3-roll mill (Osterizer brand kitchen model) to reduce the particle size. The three roll mill with internal water cooling to keep the roll surface cool during grinding was manufactured by The J.H. Day Company, Div of Cleveland Automatic Machine, Cincinnati 12, Ohio, Model 4×8. The ground material was then blended into another 272.5 grams of the fat composition in the same bowl with the temperature raised to 125° F., along with from 3.63-5.45 grams soybean lecithin as emulsifier. Mixing was continued at Hobart bowl speed #1 for 30 minutes. The composition was then cooled to 120° F., coated on to individual bars, and the coated bars were run through a cooling tunnel for 7.5 minutes at a temperature of 57-60° F. Each of the fats was found to make an acceptable solid coating product, with variations in gloss, stickiness, and time to set while in the cooling tunnel.

### EXAMPLES 7-10

### Preparation of Lipid-Protein Complexes

The following examples illustrate the process of manufacturing lipid-protein complexes on a laboratory scale in accordance with the invention. In each of the following examples, the lipid component, referred to as “fat” in the table, was fractionated palm kernel oil sold under the name CE 21-20 by Arrhus, and the protein component was instantized whey protein hydrolysate with 80% net protein, sold under the name Hilmar 8360 by Hilmar Ingredients. The grams of protein as stated in the table are the grams of this protein product. For these experiments, the particle size of the instantized protein product was reduced by grinding the protein in an Oster kitchen blender and sieving the material through a U.S. 60 mesh screen, and repeating that procedure for all material that did not pass through the screen, until the required amount of material was obtained that did pass through the screen. For each experiment, the ground instantized protein product was mixed with the amount of lipid stated in Table II below, and each composition was mixed using a bench top Silverson High Speed/shear mixer model L4RT, at the mixing speed indicated in Table II below, for 20 minutes at a temperature of 130° F., and then cooled to 110° F. with continued mixing before being placed in the freezer. Prior to cooling, the viscosity of each composition was measured at 130° F. in units of centipoise on a Brookfield Instrument (model DV-I+Viscometer) spindle-3/rpm 20. The composition, mixing speed, and viscosity of each of these LPC examples is summarized in Table II.

TABLE II
Preparation of Lipid/Protein Complex

| Example | % net protein | Composition | | Mixing speed | | Viscosity | % emulsifier |
|---|---|---|---|---|---|---|---|
| 7 | 0% (control) | 1500 | gms fat | 2000 | rpm | 900-1100 cp | No emulsifie |
| 8 | 30% | 563 | grams protein | 4000-6000 | rpm | 1460-1800 cp | 0.34%/total |
| | | 937 | grams fat | | | | LPC |
| 9 | 40% | 750 | gms protein | 4000-6000 | rpm | 2800-3000 cp | 0.45%/total |
| | | 750 | gms fat | | | | LPC |
| 10 | 50% | 935 | gms protein | 5000-7000 | rpm | 3500-4000 cp | 0.56%/total |
| | | 565 | gms fat | | | | LPC |

### EXAMPLES 11-15

### Coating Compositions with Instantized Protein Product

Each of the LPC samples of examples 7-10, and another LPC sample with 15% net protein, were used in the preparation of solid coating compositions. The coating compositions were prepared by first mixing all the dry ingredients except the LPC together in a Hobart mixer, then adding a portion of the LPC, subjecting this mixture to grinding in the 3-roll mill described above until a fine powder was obtained, then returning the finely ground mixture to the Hobart mixer and adding the remaining portion of the LPC and a small quantity of lecithin as needed, with mixing continued until the mixture is an even blend suitable for coating solid objects. In each of the examples below, the fat content (not including the fat from the cocoa) was maintained at 30%. As more protein was added, the amount of sugar was reduced to keep the batch weight constant from batch to batch. An artificial sweetener product sold under the registered trademark “Splenda” was added as necessary as sugar was removed. For each example in Table III below, the type of LPC used corresponds to the examples of Table II, above, as well as an additional LPC made with 15% net protein, which was used in Example 12. All quantities are in grams unless otherwise stated. The percent emulsifier includes both the initial emulsifier present in the instantized protein product and the lecithin that was added to the composition. The compositions of Examples 11-15 were coated onto energy bars in accordance with the parameters reported in Table III. None of these compositions exhibited stickiness when coated onto bars.

TABLE III
Preparation of Coating Composition

| | | | Example | Example | Example |
|---|---|---|---|---|---|
| | | Example | 13 | 14 | 15 |
| | Example | 12 | LPC: | LPC: | LPC: |
| | 11 | LPC: | Ex. 8 | Ex. 9 | Ex. 10 |
| | Fat: Ex. 7 | (15% net | (30% net | (40% net | (50% net |
| Ingredient | (control) | protein) | protein) | protein) | protein) |
| LPC (gms) | 546 | 672.0 | 870 | 1090 | 1448 |
| Sugar | 923.8 | 792.2 | 588.0 | 361.5 | 0 |
| (powdered | | | | | |
| 6x) (gms) | | | | | |
| Cocoa | 287 | 287 | 287 | 287 | 280 |
| powder | | | | | |
| (10-12% fat) | | | | | |
| (gms) | | | | | |
| Non fat dry | 54.5 | 54.5 | 54.5 | 54.5 | 54.5 |
| milk (gms) | | | | | |
| Extra-fine | 1.5 | 1.5 | 1.5 | 1.5 | 1.5 |
| salt (gms) | | | | | |
| Lecithin | 7.20 | 9.0 | 9.0 | 9.0 | 9.0 |
| (gms) | | | | | |
| Total wt % | 0.40% | 0.66% | 0.71% | 0.76% | 0.85% |
| emulsifier | | | | | |
| Artificial | 0 | 3.8 | 10.0 | 16.5 | 27.0 |
| sweetener | | | | | |
| (gms) | | | | | |
| % protein | 0 | 5.3 | 14.7 | 24.0 | 39.5 |
| in finished | | | | | |
| coating | | | | | |
| Coating | 117° F. | 118° F. | 118° F. | 118° F. | 118° F. |
| application | | | | | |
| temperature | | | | | |
| Tunnel | 59° F. | 58° F. | 59° F. | 58° F. | 58° F. |
| temperature | | | | | |
| % coating | 16.7 | 16.9% | 17.9 | 18.0 | 18.0 |
| deposit | | | | | |
| based on | | | | | |
| bar weight | | | | | |
| Gloss | very good | very good | very good | very good | Good/fine |
| | | | | | lines |

The present invention therefore provides a lipid-protein complex that allows about at least 10-50% protein by net weight to be incorporated into the complex, and a method of making such a complex, that can be used as a solid coating for a food product or as an ingredient in a solid coating for a food product. Where the food product is a snack food item such as an energy bar, the coating can serve as a moisture barrier to prevent hydration of the protein component of the bar, thereby preserving the energy level of the bar. The protein-rich coating can add to the protein content of the overall bar, or the protein-rich coating can allow the producer to reduce the protein content of the uncoated bar to make the bar more palatable and still provide the same level of overall protein to the consumer. Depending on the amount of protein in the coating, the amount of protein added to the bar can be in the range of about 5-40%.

An advantage of the present invention is that the coating composition can be applied at temperatures ranging from about 115-125° F., which is higher than the 110° F. coating temperature of certain prior art compositions such as that disclosed in U.S. Pat. No. 4,762,725. The higher application temperature allows a thinner coating to be applied, where desired. Further, the coating of the present invention will not break or crack off the bar, but will still melt in the mouth to provide the desired consumer appeal.

In yet another embodiment, the composition of the present invention can be used in the preparation of a confection such as a toffee-style confection, or a chocolate-candy type confection, but with a higher protein content than traditional confections. Those skilled in the art will recognize from the foregoing disclosure how parameters such as mixing speed, temperature, and proportions of ingredients can be adjusted to create a higher protein confectionery product with a consistency and palatability having appeal to consumers.

Each of the foregoing examples of the method and composition of the invention was prepared with an “instantized” form of the protein product, as stated above. As is known in the food science arts, instantized hydrolyzed whey protein is made by hydrolyzing whey protein with an enzyme to break certain bonds between amino acids in a peptide chain, then treating the hydrolyzed protein with lecithin, allowing fine particles to cluster by an agglomeration technique, and finally spray-drying the lecithin-treated product to form very small size particles. The lecithin promotes emulsification of the particles in a variety of mixtures, and promotes “wetting” of the particles with oil when the protein is added to the lipid under shear in accordance with the method of the present invention. The use of instantized whey can be beneficial in systems such as certain ones of the present invention, in which a goal is to achieve higher concentrations of protein dispersed in an oil matrix.

The use of instantized protein also can create certain challenges for the food products formulator. The lecithin in the instantized product can lead to larger initial particle sizes, and also can promote agglomerization of the spray dried particles. It therefore can be necessary to mechanically grind the solid spray dried protein product to the appropriate particle size before it can be used in the method and composition of the present invention, as noted above. Such mechanical grinding can be costly, as well as time consuming. The lecithin present in the instantized protein product also can create difficulties for food processors who use the protein lipid complex of the present invention to make slurry compositions to be used as coatings for food products. The lecithin can lower the viscosity of such slurry compositions, particularly those containing chocolate, below a value that will provide an acceptable coating on a food product. If there is less lecithin in the protein lipid complex, the food product manufacturer has greater freedom to adjust the lecithin level in a slurry composition containing the complex as may be most suitable for the needs of a particular food product being made.

Therefore, another aspect of the present invention relates to the use of a non-instantized protein product, particularly whey protein, in the lipid protein complex of the present invention. Commercially available hydrolyzed non-instantized whey protein typically has an average particle size in the range of about 50-80 microns, which is smaller than the initial average particle sizes of instantized whey protein. Thus, costly mechanical grinding, which is typically accomplished through an outside vendor, can be eliminated. The absence of additional lecithin in the non-instantized protein also affords the food product manufacturer the ability to adjust the lecithin content in the final coating slurry to obtain the viscosity desired for the ultimate food product. In a preferred embodiment of the invention, the lipid protein complex of the invention is manufactured using a double stage shear process that includes an additional high shear mixing step known in the art as “liquid grinding” to reduce the particle size of the non-instantized protein component and to achieve the desired creaminess of the final product, without the use of lecithin in any quantity that would be problematic for the food manufacturer. This liquid grinding step can be done in a semi-continuous process with the mixing of the protein into the oil as discussed in detail below, thus saving the cost of a separate grinding step prior to adding the protein particles to the oil. The non-instantized protein also is less expensive than the instantized protein products, thereby providing a further cost savings in the manufacture of the protein complex.

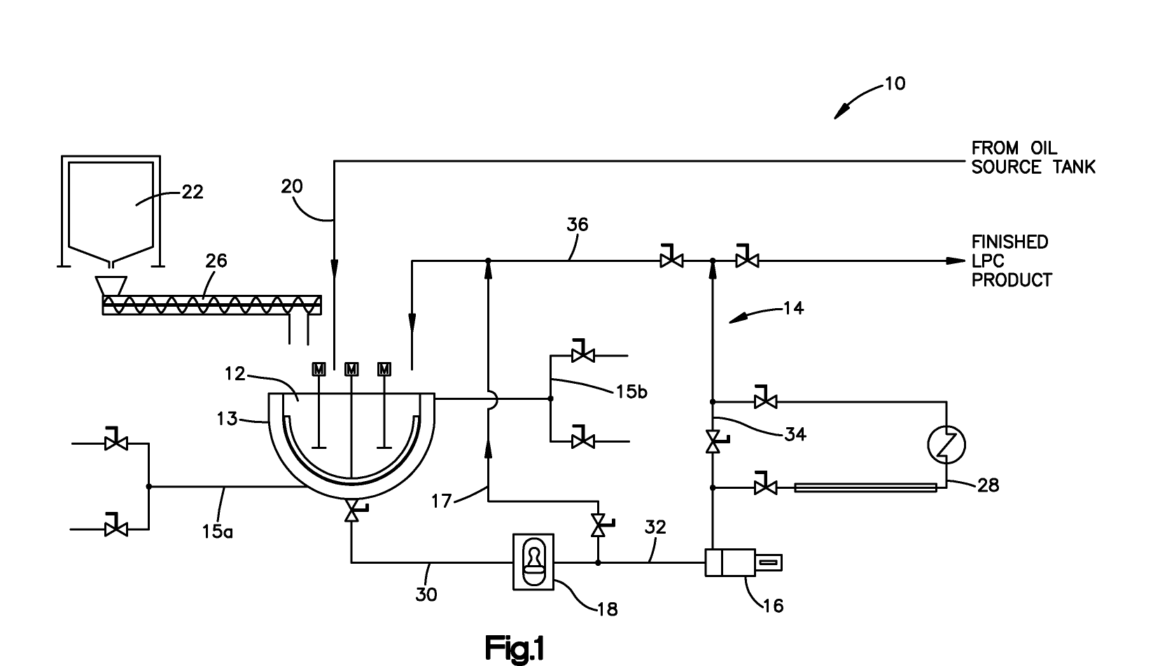

FIG. 1 illustrates a pilot plant embodiment of a system 10 that can be used to prepare a lipid protein complex of the present invention using a double stage shear process, wherein the components are not shown to scale. The system 10 comprises a primary high speed mixing tank 12 connected by a continuous loop 14 to a secondary dual stage high shear mixer 16. Continuous loop 14 comprises loop segments 30, 32, 34, and 36. Primary high speed mixing tank 12 is provided with a heating and cooling system. In the illustrated embodiment, the heating and cooling system comprises a jacket 13 which is fed by water supply 15a and water return 15b. Secondary high shear mixer 16 also may be provided with a heating unit, not shown, which may be of the same or a different type from that used for primary high speed mixing tank 12. Circulation of material between the primary high speed mixing tank 12 and secondary high shear mixer 16 via continuous loop 14 can be provided by positive displacement pump 18. The optimum operating temperature for primary high speed mixing tank 12 is in the range of about 130-140° F., because it is considered undesirable for the whey component to reach a temperature of 150° F. for any substantial period of time. Prior to the addition of the protein component to the system 10, the lipid component in the form of liquid oil at a temperature of about 145-150° F. is added via oil inlet 20 to primary high speed mixing tank 12. The mixing tank agitator operates at about 1500-1700 rpm, and the viscosity of the lipid in the mixer is about 50 centipoise at 135° F. The oil is pumped through continuous loop 14 and secondary high shear mixer 16 via pump 18, which can be a 3 horsepower shear pump operating at 30-100% speed, until the temperature of the system is stabilized at about 130-140° F. A small amount of emulsifier such as lecithin can be added to the lipid during this step, if desired. Alternatively, a small amount of emulsifier can be incorporated into the protein to be added to the system, generally in the range of about 0.1-0.4%, the amount of emulsifier being so small that the protein can be regarded as substantially emulsifier free. Regardless of source, the amount of emulsifier is less than 1%, preferably less than 0.5%, and most preferably less than 0.2%, based on the weight of the total batch mixture of the final lipid protein complex.

Once a temperature of the system 10 is established, a protein product is added from hopper 22 to primary high speed mixing tank 12 via a dispenser such as auger mixer 26. The protein product preferably comprises a non-instantized protein product in whole or in part. If the protein product comprises one or more protein products, they can be introduced from one or more hoppers 22 to an optional blender, not shown. The optional blender serves to promote the free flow of the powdered protein component, and, if two or more different protein products are used, the blender also promotes the even mixing of those protein products. The blended protein component then passes from the optional blender to auger mixer 26. Whether carrying a single component protein product or a blended protein product, auger mixer 26 meters the delivery of the protein component to the primary high speed mixing tank 12 at a desired rate of weight of protein per unit time, the primary high speed mixing tank 12 already containing a quantity of pre-warmed liquid oil as described above. The protein component delivery rate can be adjusted by adjusting the speed of the internal screw in the auger mixer 26, as is known in the art.

In the primary high speed mixing tank 12 the protein product and the liquid oil are mixed at about 1500-1700 rpm. During the addition of the first half of the protein-containing product, the liquid blend is pumped via pump 18 from tank 12 through loop segment 30 and then through bypass 17 to loop segment 36 and back to primary mixer 12. After about half the solid is added for a particular batch, at least a portion of the product stream passes through loop segment 30 and pump 18, and then through loop segment 32 to secondary high shear mixer 16. At this stage in the process diversion valve 42 leading back to primary high shear mixer 12 is open and diversion valve 44 leading to an exit of the system is closed, such that the product stream continues from loop segment 34 to loop segment 36 and back to the primary high shear mixer 12.

While in secondary high shear mixer 16, the product is subjected to liquid grinding to reduce the particle size of the protein particles. In a preferred embodiment, high shear mixer 16 comprises a multi-stage in-line mixer, incorporating an inner rotor and an outer stator assembly. One acceptable high shear mixer 16 is available under the name 450 LS Inline mixer from Silverson Machines, Inc. of East Longmeadow, Mass. In accordance with the operation of that unit, the inner rotor initiates a suction action to draw the feed inside a cage and first subjects the product to an initial mixing action, then reduces the size of the particles and produces a more uniform product by milling the particles between the tips of the rotor blades and the inner surfaces of the stators. This is followed by intense hydraulic shear as the materials are forced, at high velocity, out through the perforations in the stator, then through the machine outlet and along the pipeline. This mechanical work creates heat which builds up in the slurry/mixture while circulating through loop 14. Usually gradual addition of particulate protein (at room temperature) in the mixer maintains the temperature within target range, otherwise means for cooling can be provided, as are known in the art. At the same time, fresh materials are continually drawn into the secondary high shear mixer 16, maintaining the mixing and pumping cycle. The inner rotor also acts as a primary mover, moving the product to the outer rotor assembly. Other mixers that accomplish liquid grinding will be known to those skilled in the mixing arts. Mixing times and temperatures will depend on parameters such as the initial particle size distribution of the incoming protein product, the amount of protein product relative to the amount of lipid product, the total amount of material in a batch and the capacity of the mixing equipment. The optimization of such variables in accordance with any particular product to be made will be known to those skilled in the art.

In the process diagram of FIG. 1, optional by-pass line 17 of loop 14 extending from loop segment 32 to loop segment 36 allows the system operator to regulate the flow of the mixed stream through secondary shear mixer 16 as needed. If the flow rate is too high and lowers grinding efficiency, then a portion of the flow can be diverted through bypass line 17 back to the mixing tank 12. The flow towards shear mixer 16 can thereby be reduced to reduce the load on the shearing system, or increased to create a higher throughput, thereby attaining greater efficiency, as long as product properties are maintained. Also, the flow rate through secondary high shear mixer 16 can be adjusted to raise or lower batch temperatures. In addition, the temperature of the output of secondary high shear mixer 16 can be moderated by passing the mixture either directly or via a bypass through heat exchanger 28.

The lipid protein complex thus prepared will be a liquid at the operating temperatures of the system, about 130-135° F. When an acceptable emulsion has been obtained, valve 44 can be opened and product can be removed from the system. Depending on the particular composition, the product will begin to solidify at temperatures below about 90° F., and will become hard when maintained at a temperature of about 80° F. for a period of several hours. The finished lipid protein complex thus can be packaged in any of several forms, depending on customer need. In one embodiment, the mass can be cooled through a crystallizer unit to a temperature of about 80° F. to a semi-solid consistency, and then packed in 50 pound cubes and cooled to 65-72° F. Alternatively, the liquid protein lipid complex at 130-135° F. can simply be poured into appropriate containers, such as 5 gallon buckets, and placed in a cold room at 10° F. for conversion into a solid mass. The solid masses can then be unloaded into packaging containers, such as fifty pound capacity boxes. In yet another embodiment, the liquid lipid protein complex can be taken from the mixer directly to a flaker unit, such as is known in the art, and converted into flakes, packed in lined boxes, and left at ambient temperature. In still another embodiment, the liquid protein complex at 130-135° F. can be poured directly into steel drums and shipped to the customer. It is expected that at least partial solidification of the complex may occur during shipping. The customer can apply post-treatment, if necessary, such as by placing the drum in a heat box for 24 hours at 120-125° F. to liquefy the complex.

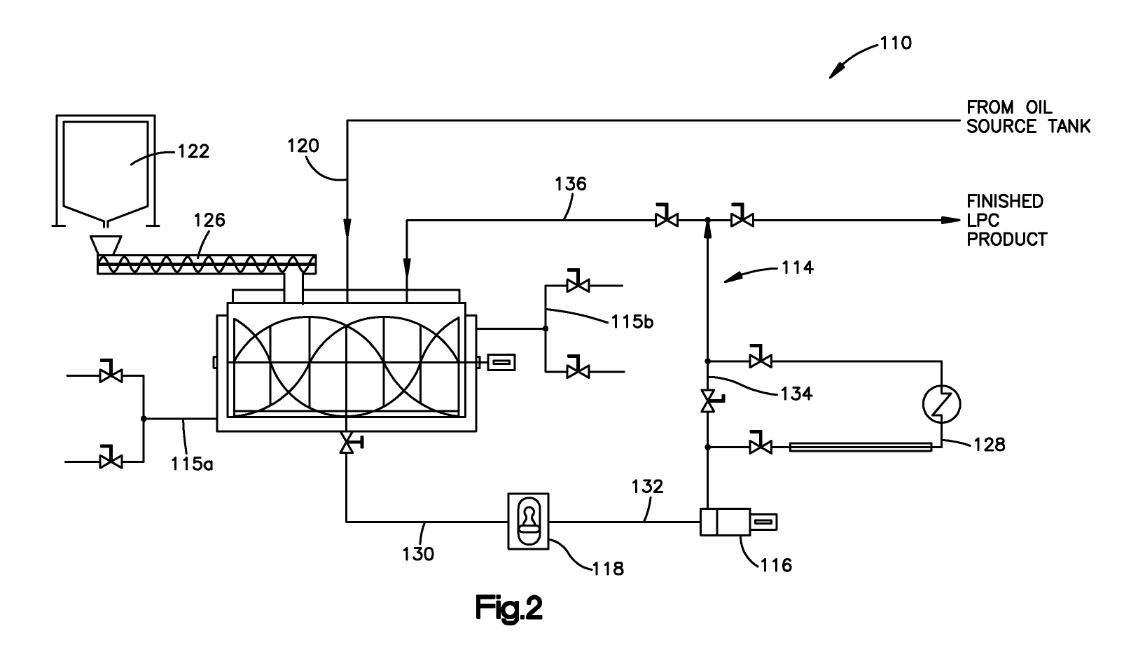

FIG. 2 illustrates a schematic diagram for a full-scale production facility 110 for the method and product of the present invention, with the components thereof not being drawn to scale. It may be seen that the system is substantially the same as the pilot plant system illustrated in FIG. 1. In the illustrated embodiment, primary high speed mixing tank 112 can be in the form of a ribbon blender, as shown, or alternatively a vertical lift hydraulic cylinder attached with two independently driven agitators, including an anchor and a High Speed Dispenser manufactured by Charles Ross & Son; all such apparati being known in the art. Primary high speed mixer 112 also can be any other vertical mixer assembly in which high speed mixing along with side scraping action allows for thorough wetting of the protein particles by the lipid. Primary high speed mixer 112 is connected by a continuous loop 114 to a secondary high shear mixer 116. Primary high shear mixer 112 and secondary high shear mixer 116 each may be provided with heating units; in the illustrated embodiment, primary high speed mixer 112 is provided with a jacket 113 through which heated or cooled water can pass, as is known in the art. Circulation of material between the primary high speed mixer 112 and secondary high shear mixer 116 via continuous loop 114 is provided by pump 118. The optimum operating temperature for primary high speed mixer 112 is in the range of about 130-140° F. Prior to the addition of the protein component to the system 110, the lipid component in the form of liquid oil at a temperature of about 145-150° F. is added via oil inlet 120 to primary mixer 112. Primary high speed mixer 112 operates at a speed equivalent to about 1500-1700 rpm; for a vertical lift hydraulic cylinder having three speed settings, this range corresponds to the first and second settings. The viscosity of the lipid in the primary mixer 112 is about 50 centipoise at 135° F. The oil is pumped through continuous loop 114 and secondary high shear mixer 116 until the temperature of the system is stabilized at about 130-140° F. A small amount of emulsifier such as lecithin can be added to the lipid in primary high speed mixer 112, either as part of the protein component, or as a separate addition to the primary high speed mixer 112, or both, as explained above with respect to the system of FIG. 1. Once a temperature of the system 110 is established, a protein component, which can comprise one or more protein products, is introduced to primary high speed mixer 112 from one or more hoppers 122 via screw powder conveyer 126. The protein product preferably comprises a non-instantized protein product in whole or in part. If more than one protein product is used, the protein products will be sufficiently mixed in conveyor 126. Alternatively, an optional blender, not shown, may be used as discussed above. The protein component then passes to the primary high speed mixer 112 at a desired rate of weight of protein per unit time, the primary high shear mixer 112 already containing a quantity of pre-warmed liquid oil as described above.

The protein-oil slurry initially can be circulated through continuous loop 114 to secondary high shear mixer 116. It was found in studies conducted with the pilot plant system illustrated in FIG. 1 that the secondary high shear mixer could process all of the output of the primary high speed mixer; therefore, the optional by-pass line 17 was not included in the system of FIG. 2, although it could be added for particular applications as desired. The secondary high shear mixer 116 can be a multi-stage in-line mixer with liquid grinding as described above in relation to the system of FIG. 1. Additional protein can be added into primary high speed mixer 112 as the high speed process proceeds. Processing through the system 110 then continues until a desired viscosity and temperature are reached. The final protein lipid complex can then be cooled and packaged as described above.

The following Examples 16-22 were conducted using the system illustrated in FIG. 1. In each of the following Examples 16-22, the protein was either instantized Hilmar 8360 instantized whey protein product as described above, or non-instantized Hilmar 8350 hydrolyzed whey protein product containing about 80% protein, or a mixture of the two, as indicated. The instantized protein product, where used, was first subjected to mechanical grinding by Fluid Energy Processing & Equipment Company (Fluid Energy Aljet), 4300 Bethlehem Pike, Telford, Pa. 18969 to an average particle size of about 30-60 microns. The non-instantized protein product was not subjected to pre-grinding. The lipid component was fractionated palm kernel oil available from Bunge Oils, Inc. under the designation F301K, the primary high speed mixer 12 was operated at about 1500-1700 rpm, and the secondary high shear mixer 16 was operated at its highest setting, equivalent to about 7500-8000 rpm.

### EXAMPLE 16

A pilot plant unit as generally illustrated in FIG. 1 has a primary high speed mixer 12 comprising a 100 pound kettle attached to a flaker unit, such as is known in the art. The primary high speed mixer was charged with 35 pounds of fractionated palm kernel oil available from Bunge Oils, Inc. under the designation F301K, along with 32 grams of lecithin, all at a temperature of 160°. The hot oil was circulated through the continuous loop 14 and high shear mixer 16 until a steady state temperature of 135° F. was achieved. The protein used was non-instantized Hilmar 8350 hydrolyzed whey protein product, which was used as received from the supplier and was not mechanically ground before addition to the system. Initially 17.9 pounds of the whey product was added to the primary mixer over a four minute period, causing the temperature in the mixer to drop to 118° F. The remaining 17.1 pounds of the whey product was added over a period of eleven minutes. Throughout the addition of the protein product, the blend of lipid and protein was circulated throughout loop 14 with about half passing through secondary high shear mixer 16 and about half passing through by-pass stream 17. When all the whey product had been added, mixing continued through the system for one hour at 124° F., the flow rate from the dual stage high shear mixer 16 was 3.85 lbs/10 sec., or 1390 lbs/hr, and the flow rate through by-pass stream 17 was 3.80 lbs./10 sec., or 1370 lbs/hr. Samples taken after one hour of mixing had noticeable graininess. After one and a half hours of mixing, the flow rates through the sheared stream and the by-pass stream were 1780 lbs/hr (4.95 lbs/10 see) and 1800 lbs/hr (5.0 lbs/10 see), respectively, at 133° F. A sample taken at this time had a slightly grainy texture. After two hours of mixing, the temperature dropped slightly to 130° F., and the flow rate of the by-pass system had dropped to 1625 lbs/hr (4.50 lbs/10 sec). A sample taken at this time was comparatively smoother than the samples taken after one hour and one and a half hours of mixing. The viscosity of the first sample taken was 1800 cp, and the viscosity of the last sample taken was 650 cp, the decrease in viscosity resulting from the shear action on the material, which led to more efficient particle size reduction and consequently more uniform dispersion of the whey protein particles in the oil, for a good emulsion of the total batch

### EXAMPLE 17

A procedure was followed substantially as described in Example 16 above, but using a protein blend comprising 20 parts Hilmar instantized 8360 whey product and 80 parts Hilmar non-instantized 8350 whey product. No extra emulsifier was added to the mixture. The emulsifier present in the 20 parts instantized protein product brought the lecithin to 0.1% by weight of the total batch. Thirty pounds of fractionated palm kernel oil available from Bunge Oils, Inc. under the designation F301K was circulated through the system to establish a temperature of 130° F. Fifteen pounds of the whey blend was added to the oil in the primary high speed mixer 12 over a period of about 5-7 minutes. During this initial mixing, the mixture was circulated by pump means 18 through by-pass line 17, so that the mixture did not pass through secondary multi-stage shear mixer 16 or segments 34 or 36 of continuous loop 14. After this initial mixing step was complete, this mixture was then circulated through the entire system including the secondary high shear mixer 16 for about five minutes, to initiate the liquid grinding process. The remaining fifteen pounds of whey protein blend then was added to the mixture over a period of about 15-20 minutes, with the temperature of the mixture at about 123° F. After one hour of mixing through the entire system, the flow rate was 1940 lbs/hr through the secondary high shear mixer 16 and 1180 lbs/hr through the bypass line 17, the mixture having a viscosity of 850 cp. This relatively lower viscosity indicates that the initial mixing step and the gradual introduction of the whey product into the secondary multi-stage high shear mixer 16 served to avoid overloading of the secondary multi-stage high shear mixer 16, thus allowing grinding to proceed more efficiently, as reflected in a narrower particle profile and thus lower viscosity. After one and a half hours, the flow rate was 1500 lbs/hr through the secondary high shear mixer 16 and 1180 lbs/hr through the bypass line 17, the mixture having a viscosity of 480 cp and a temperature of 128° F. After two hours of mixing the viscosity was 380 cp and the temperature was 131° F.

### EXAMPLE 18

A procedure was followed substantially as in example 17 above, except that the whey product used was 100% Hilmar 8350 non-instantized whey product. Thirty pounds of the same F301K oil with 27.5 grams lecithin was circulated through the system to warm it prior to the addition of solids. Fifteen pounds of the non-instantized whey was added to primary high speed mixer 12 over a period of 11 minutes, and then allowed to pass to secondary multi-stage high shear mixer 16. The remaining fifteen pounds were added to primary high speed mixer 12 over a period of 12 minutes, with continuous flow through to secondary multi-stage high shear mixer 16. After forty minutes from the time addition of solids commenced, the temperature was 110° F. and the batch looked thick. After thirty minutes of mixing from the time all the solid had been added, the flow rate through secondary high shear mixer 16 was 1245 lbs/hr (56% of total flow), the flow rate through the bypass stream 17 was 975 lbs/hr (44% of total flow), and the viscosity was 690 cp, with the material at 136° F. At this stage, the flow rate through by-pass 17 was adjusted such that the flow rate through loop 17 and the flow rate through secondary high shear mixer 16 was divided into 50/50 to control the rise in temperature. After one hour of mixing from the time all solids had been added, the flow rate was 1180 lbs/hr through the secondary high shear mixer 16 and 1150 lbs/hr through the bypass stream 17, the mixture having a viscosity of 470 cp and a temperature of 132° F. This material was found to be suitable for use in the preparation of a food coating composition containing chocolate.

### EXAMPLE 19

A procedure was followed substantially as in Example 18 above, except that the goal was a batch having 40 parts F301K lipid and 60 parts Hilmar 8350 non-instantized whey protein product Initially, 30 pounds of the lipid at 150-160° F. was added to the primary high speed mixer 12 along with 34 grams of lecithin, and circulated through the pump 18 and the by-pass stream 17 to warm up the system. Twenty-nine pounds of the whey product was added to the primary high speed mixer 12 over a period of about ten minutes to form a slurry, which slurry was then allowed to pass continuously through the secondary multi-stage high shear mixer 16 for a period of forty minutes. The temperature rose to 142° F., and the temperature control system 15 for primary high speed mixer 12 was turned off. An additional seven pounds of the whey product was added to primary high speed mixer 12 to reach a ratio of about 55 parts of whey per about 45 parts oil, and mixing continued for another hour. The viscosity of the product at that point was 3750 cp at 147° F. After 1½ hours of total mixing the viscosity was found to have decreased to 2850 cp, and four tray quantities at approximately 5 lbs of material per tray were collected. It was concluded that when the proportion of whey protein in the sample exceeds 50%, it can become difficult to control both the process viscosity and the temperature of the system. In such situations, a more powerful pump 18 can be used to drive the material to high shear mixer 16.

### EXAMPLE 20

An attempt was made to make a 75 pound batch of lipid protein complex of 60% protein product and 40% oil, using 30 pounds of oil and 45 pounds of a protein blend comprising 20% Hilmar 8360 instantized whey protein and 80% Hilmar 8350 non-instantized protein. No additional lecithin was added. The oil was used to warm the system as described above, and the whey blend was added gradually. After 40 pounds of the whey mixture had been added, it was found that there was no more room in the primary high speed mixer 12 for the additional five pounds of whey mixture. The mixture was thus 57% protein product and 43% oil. The amount of lecithin was based solely on the lecithin present in the instantized whey protein component of the protein mixture, and was 0.103% lecithin in the final batch. After the forty pounds of whey mixture was added, mixing continued for 45 minutes, the viscosity reached 3880 cp at 137° F., and a sample was collected. Fifteen minutes later, the viscosity was 3260 at 146° F., and another sample was collected. The two samples were used to make coatings as described in connection with table 3 above. These samples were found to be less than ideal in terms of applicability to a food item and flowability of the coating. No further tests were done on these samples.

### EXAMPLE 21

An attempt was made to make a 75 pound batch of lipid protein complex using 30 pounds of oil, 32.0 grams of lecithin, and 45 pounds of Hilmar 8350 non-instantized whey product. As with the above Example 20, it was found that only 40 pounds of the whey product could be added to the system. The whey was added gradually into the oil. For the first five minutes, the whey was slowly added to primary high speed mixer 12 with all fluid circulation directed through bypass line 17, then over the next ten minutes the remainder of the whey was slowly added while circulation was diverted away from bypass line 17 and into secondary high shear mixer 16. It was observed that the temperature slowly started to rise. After 40 minutes from the time flow started through the secondary high shear mixer 16, the temperature had reached 147 F and the viscosity was in the range of about 3600 cp-3800 cp. After another 45 minutes of mixing the viscosity was about 3500 cp @ 145 F, which is not considered an appreciable change. It is believed that a more powerful pump 18 to feed in-line secondary high shear mixer 16 might allow for greater flow-through of material and reduce the viscosity of material so that additional protein could be added.

### EXAMPLE 22

In the preparation of a protein lipid complex containing pea protein isolate, 25 pounds of the F310K oil was introduced to primary high speed mixer 12 at 160° F. and was allowed to circulate through the entire system including the secondary high shear mixer 16 until the oil temperature was at 130-135° F. Twelve pounds of pea protein isolate obtained from Roquette Freres, 62080 Lestrem Cedex, France, and sold under the trade name “NUTRALYS” soluble pea protein, containing about 84% protein and no emulsifier, and having an average particle size of about 90-130 microns, was gradually added to primary mixer 12 with high speed mixing of about 750-1100 rpm for ten minutes. The mixing speed was lower than the mixing speed used for whey protein to avoid foaming problems that might otherwise occur with the pea protein. The blend was allowed to circulate through secondary high shear mixer 16 for thirty minutes, until it reached a viscosity of 2600 cp at 128° F. An additional 13 pounds of the pea protein isolate was then added to the system with constant mixing in the primary mixer at 750-1100 rpm, and the total mixture was allowed to circulate through the secondary high shear mixer 16 for one hour, until it reached a viscosity of 1875 cp at 130° F. Mixing was continued for another hour, and the resulting slurry was poured into a shallow tray and cooled into a one-inch slab for evaluation. The finished product was a bit coarse in texture and carried a distinct flavor different from that of whey LPC.

The results of Examples 16-22 are summarized in the following Table 4

TABLE 4

| | % net | | | | |
|---|---|---|---|---|---|
| | protein | | | | |
| | (Total | | | | |
| | weight | | | | |
| | of | | Initial | Final | |
| Ex- | whey × | | viscosity | viscosity | % |
| ample | 0.8) | Composition | (cp) | (cp) | emulsifier |
| 16 | 40.0% | 50% fat | 1850 | 650 | 0.10% |
| | | 50% non- | | | |
| | | instantized whey | | | |
| | | product | | | |
| 17 | 40.0% | 50% fat | 850 | 380 | 0.10% |
| | | 40% non- | | | |
| | | instantized whey | | | |
| | | product | | | |
| | | 10% instantized | | | |
| | | whey product | | | |
| 18 | 40.0% | 50% fat | 690 | 470 | 0.10% |
| | | 50% non- | | | |
| | | instantized whey | | | |
| | | product | | | |
| 19 | 44.0% | 45% fat | 3750 | 2850 | 0.10% |
| | | 55% non- | | | |
| | | instantized whey | | | |
| | | product | | | |
| 20 | 45.6% | 43.0% fat | 3880 | 3260 | 0.13% |
| | | 42.7% non- | | | |
| | | instantized whey | | | |
| | | product | | | |
| | | 14.3% instantized | | | |
| | | whey product | | | |
| 21 | 45.6% | 43% fat | 3800 | 3500 | 0.1% |
| | | 57.0% non- | | | |
| | | instantized whey | | | |
| | | product | | | |
| 22 | 42.0% | 50% fat | 2600 | 1875 | 0% |
| | | 50% pea protein | | | |
| | | isolate | | | |

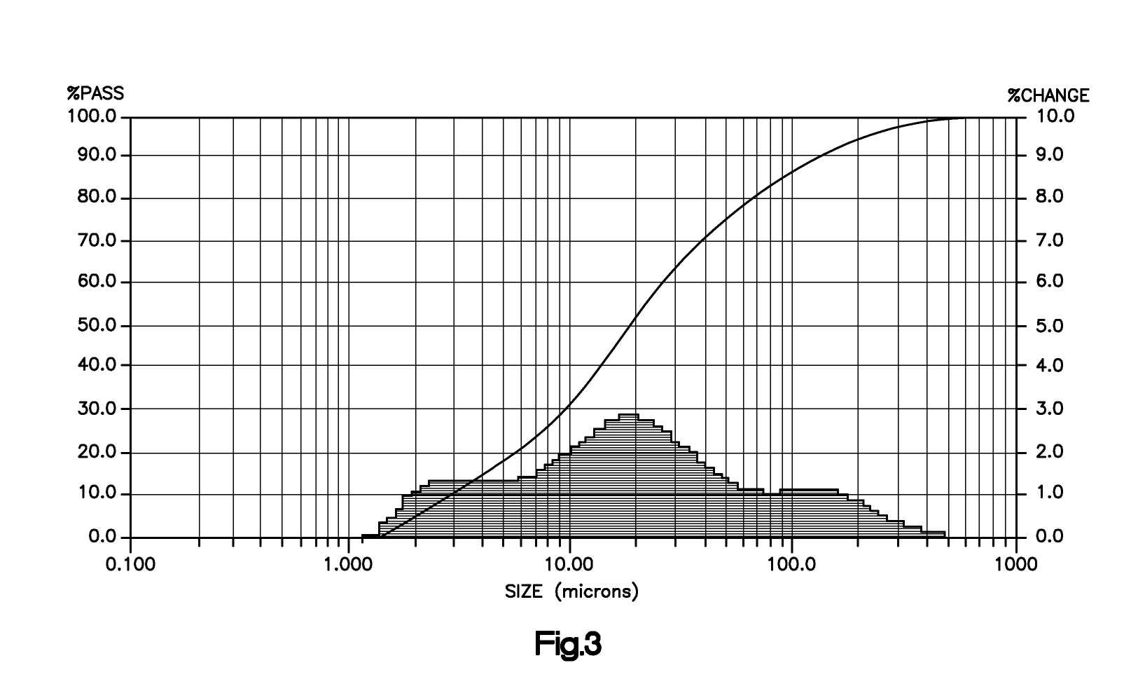

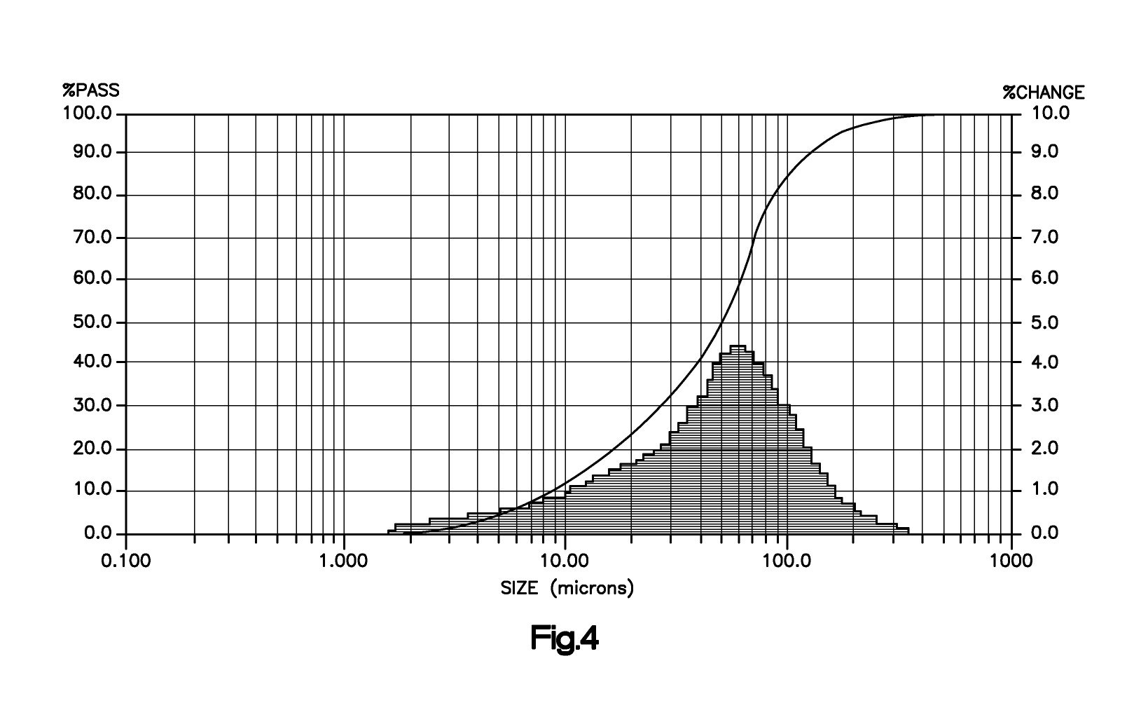

The use of the dual stage in-line high shear mixer with liquid grinding eliminates the need for separate mechanical grinding of the protein before it is added to the oil, and allows less lecithin to be used in the overall lipid-protein complex because a substantially lecithin-free protein product can be used, namely, a non-instantized protein product. Yet another advantage of the present invention is that the finished product has a much narrower particle distribution, which results in a food product coating with a smoother texture. Reference is made to FIGS. 3 and 4 which are particle size profiles of individual lipid protein complexes (LPC's) in the solid state. Particle size as illustrated in FIGS. 3 and 4 was measured as follows. Five grams of the subject LPC was melted and mixed thoroughly with 95 ml soybean oil to make a slurry. One ml of the mixed slurry was fed into an optical laser-beam-operated particle measurement unit sold under the name Microtrac S3000. This instrument provides a statistical distribution of particle sizes of an LPC sample analyzed as liquid. The instrument produces individual graphs and tables which provide detailed particle size distributions of samples evaluated. Other instruments that measure particle size distributions are known to those skilled in the art.

The LPC of the profile of FIG. 3 was the product of Example 10 above, i.e., made with instantized whey (Hilmar 8360) that had been mechanically ground to a particle size of 30-70 microns, prior to being made into the LPC. The LPC of the profile of FIG. 3 had a lecithin content of 0.45%, and the LPC was made with the single shear process using a Lightnin Mixer and an aerator. The LPC of the profile of FIG. 4 was the product of Example 16 above, made with non-instantized whey (Hilmar 8350) having a particle size of about 50-80 microns, the lipid protein complex having a lecithin content of about 0.10%, the LPC being made with the double shear process including liquid grinding. In each case, the complexes were made with about 50% oil product and 50% whey protein product. It may be seen that the material illustrated in FIG. 3, made with mechanically ground instantized whey and subjected to a single shear mixing process had a substantially flatter profile, while the material illustrated in FIG. 4, made with non-instantized whey and subjected to a dual-stage shear process with liquid grinding, had a substantially narrower profile. The sharper particle distribution profile of FIG. 4 indicates a higher quality material for use in the manufacture of food coating products, because coating made with an LPC having the particle distribution of FIG. 4 will have a smoother, more desirable texture.

The foregoing description and examples are presented by way of illustration and not by way of limitation. Those skilled in the art will recognize that the principles of this invention can be applied in several ways, only a few of which have been exemplified herein, and other modifications and equivalents will be apparent. For example, the protein can be added to the lipid while the lipid is undergoing high shear, or the protein can be added to the lipid with lower speed mixing to create a blend, and the blend can then be subjected to high shear to create an emulsion. Further, while the present examples used tip to about 50% net protein in the lipid-protein complexes, it is believed that complexes having higher levels of protein can be achieved with higher capacity pumps and shear apparatus, and such complexes are considered to be within the scope of the present invention. Accordingly, the scope of the invention is defined by the appended claims.

What is claimed is:

1. A method for forming a complex of a protein-containing material and a lipid-based material, the method comprising the steps of
admixing a quantity of protein-containing material into a quantity of lipid-based material,
applying a shear force to said admixture to form an emulsion of protein material in said lipid material, and
cooling said admixture to form a lipid-protein complex.

2. The method of claim 1 wherein said step of applying said shear force to said admixture occurs substantially simultaneously with the step of admixing said quantity of protein-containing material into said quantity of lipid-based material.

3. The method of claim 1 wherein said step of applying said shear force to said admixture occurs substantially after the step of admixing said quantity of protein-containing material into said quantity of lipid-based material.

4. The method of claim 3 further including liquid grinding of the emulsion.

5. The method of claim 1 wherein said shear force is applied by a mixer rotating at about 4000-10,000 rotations per minute.

6. The method of claim 1 wherein said lipid material is heated to a temperature of about 125-150° F. prior to the admixing of said protein-containing material.

7. The method of claim 1 wherein said lipid material comprises at least one lipid-containing material selected from the group consisting of palm kernel oil, fractionated palm kernel oil, palm kernel stearine, palm oil, canola oil, cottonseed oil, corn oil, soybean oil, sunflower oil, olive oil, peanut oil, coconut oil, cocoa butter, butter fat, dairy fat, and pure palm kernel stearine fractions, and blends of any of the foregoing.

8. The method of claim 1 wherein said at least one lipid-containing material is selected from the group consisting of a non-hydrogenated lipid, a partially hydrogenated lipid, a fully hydrogenated lipid, an interesterified lipid, and a fractionated lipid.

9. The method of claim 1 wherein said protein-containing material comprises at least one protein selected from the group consisting of whey protein concentrate, whey protein isolate, whey protein hydrolysate, soy isolate, soy concentrate, milk casein, calcium caseinate, calcium sodium caseinate, milk protein isolates, pea flour, pea protein isolates, beta-lacto globulin, and alpha-lactalbumin.

10. The method of claim 1 wherein said protein-containing material is substantially free of emulsifiers.

11. The method of claim 1 wherein said protein-containing material further comprises an emulsifier.

12. The method of claim 1 wherein said protein-containing material is added in an amount said admixture contains at least about 10-50 net weight % protein.

13. The method of claim 1 comprising the further step of adding an emulsifier to said admixture.

14. The method of claim 13 wherein said emulsifier is selected from the group consisting of lecithin and poly glycerol poly ricinoleate (PGPR).

15. The method of claim 1 wherein said protein-containing material comprises particles in the size range of about 10-80 microns.

16. An edible lipid-protein complex comprising at least about 10-50 net weight % protein, no more than about 1% of an emulsifier, and an amount of a lipid-containing material sufficient to form an emulsion with the protein containing material.

17. The edible lipid-protein complex of claim 16 wherein said lipid material comprises at least one lipid-containing material selected from the group consisting of palm kernel oil, fractionated palm kernel oil, palm kernel stearine, palm oil, canola oil, cottonseed oil, corn oil, soybean oil, sunflower oil, peanut oil, olive oil, coconut oil, cocoa butter, butter fat, dairy, fat, and pure palm kernel stearine fractions.

18. The edible lipid-protein complex of claim 16 wherein said at least one lipid-containing material is selected from the group consisting of a non-hydrogenated lipid, a partially hydrogenated lipid, a fully hydrogenated lipid, an interesterified lipid, and a fractionated lipid.

19. The edible lipid-protein complex of claim 16 wherein said protein-containing material comprises at least one protein selected from the group consisting of whey protein concentrate, whey protein isolate, whey protein hydrolysate, soy isolate, soy concentrate, milk casein, calcium caseinate, calcium sodium caseinate, milk protein isolates, pea flour, pea protein isolates, beta-lacto globulin, and alpha-lactalbumin.

20. The edible lipid-protein complex of claim 16 wherein said protein containing material is substantially free of emulsifiers.

21. The edible lipid-protein complex of claim 16 wherein said protein-containing material further comprises an emulsifier.

22. The edible lipid-protein complex of claim 21 wherein said emulsifier is selected from the group consisting of lecithin and poly glycerol poly ricinoleate.

23. An edible composition comprising the lipid-protein complex of claim 16.

24. The edible composition of claim 23 wherein said composition is a coating for a food product.

25. A food article having a coating, said coating comprising an edible lipid-protein complex comprising at least about 10-50 net weight % protein, no more than about 1% of an emulsifier, and an amount of a lipid-containing material sufficient to form an emulsion with the protein containing material.
